(19) United States
(12) Patent Application Publication
(10) Pub. No.: US 2005/0065915 A1
(43) Pub. Date: Mar. 24, 2005

(54) Method and system to add protocol support for network traffic tools

(76) Inventor: Wayne J. Allen, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/669,311

(22) Filed: Sep. 23, 2003

(51) Int. Cl. G06F 17/30

(52) U.S. Cl. 707/3

(57) ABSTRACT

A method and system to add protocol support for network traffic tools is described. The method includes querying a file that defines a protocol for which protocol support is to be added to a network traffic tool, determining from the queried file how packets for the protocol are constructed, and building a protocol runtime specification based on how packets for the protocol are constructed.

### BACKGROUND

1. Technical Field

Embodiments of the invention relate to the field of network traffic tools, and more specifically to adding protocol support for network traffic tools.

2. Background Information and Description of Related Art

A significant amount of development is required to add new protocol support to current network traffic generation and analysis tools. Therefore, when customers of these tools want a new protocol to be supported, they must wait for the new protocol support to be developed and released. Thus, customers are not able to get new protocol support quickly or easily.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a flow diagram illustrating a method according to an embodiment of the invention.

FIG. 3 is a flow diagram illustrating a method according to an embodiment of the invention.

FIG. 4 is a block diagram illustrating a suitable computing environment in which certain aspects of the illustrated invention may be practiced.

### DETAILED DESCRIPTION

Embodiments of a system and method to add protocol support for network traffic tools are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

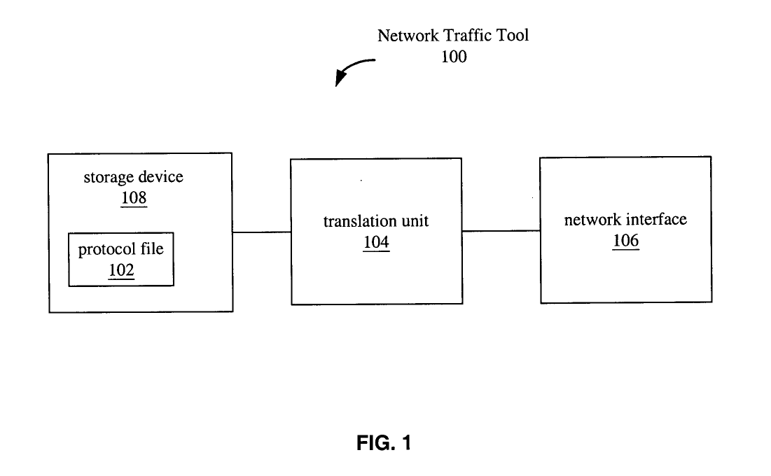

Referring to FIG. 1, a block diagram illustrates a network traffic tool 100 according to one embodiment of the invention. Those of ordinary skill in the art will appreciate that the network traffic tool 100 may include more components than those shown in FIG. 1. However, it is not necessary that all of these generally conventional components be shown in order to disclose an illustrative embodiment for practicing the invention.

Network traffic tool 100 includes a storage device 108, such as a memory, which stores one or more protocol files 102 that define protocols to be supported by the tool 100. A translation unit 104 reads and interprets the protocol file 102, determines how packets for the defined protocols are constructed, and builds a runtime protocol specification. The translation unit 104 may then execute and translate data into a proper format and create and analyze network traffic. The network traffic tool 100 may also include a network interface 106 to provide an interface with a network driver or network card.

The protocol file 102 may be created or edited by a user when the user wants a new protocol to be supported by the network traffic tool 100. The user defines the new protocol in the protocol file 102. The definition of the new protocol may include protocol encapsulations, field parameters, such as location, type, size, and calculation parameters. The translation unit 104 reads the protocol file 102, which includes the new protocol, and builds a protocol runtime specification based on definitions and parameters in the protocol file 102.

In one embodiment, the protocol file 102 is written in the Extensible Markup Language (XML). Table 1 is an exemplary table of syntax that may be used to create an XML protocol file. As shown in Table 1, there is a protocol header that indicates how many protocols are encapsulated in the packet, which protocols are being encapsulated, and the type and order of the encapsulations defined in the file. The fields of each protocol may be defined, including the location, data, type, size, and any default values. Any calculations that need to be done for a field may also be defined, including the calculation type, starting point, and ending point. Whether a field is allowed to be edited by the user at runtime may also be indicated.

TABLE 1
Exemplary Syntax

| Syntax | Example | Description |
|---|---|---|
| <Protocol> | <Protocol> | This protocol header indicates the number |
| | <Count>3</Count> | and types of protocols that will be |
| | <Encapsulation>TCP:IP</Encapsulation> | encapsulated in the traffic being defined by |
| | <Header_1>MAC</Header_1> | the file, and the order by which these |
| | <Header_2>IP</Header_2> | encapsulations are constructed. |
| | <Header_3>TCP</Header_3> | |
| | </Protocol> | |
| <Count> | <Count>3</Count> | Indicates the number of encapsulations. |
| <Encapsulation> | <Encapsulation>TCP:IP</Encapsulation> | Indicates protocol encapsulation. |
| <Header_[#]> | <Header_1>MAC</Header_1> | Indicates the ordering of headers and type of |
| | | defined protocol. |
| <[protocol]>: | <TCP:IP> | Defines the encapsulated protocols (example: |
| <[protocol]> | | TCP encapsulated in IP). |
| [protocol]::[field] | IP::Source IP | Refers to the location or data of the field |
| | | contained within the specified protocol. |
| <Type> | <Type>IP Address</Type> | Indicates the field type. |
| <Size> | <Size>16</Size> | Indicates the field size in bits. |
| <Default> | <Default>10.0.0.1</Default> | Indicates the field default value. |
| <Allow Edit> | <Allow Edit>True</Allow Edit> | Defines the field access control. This is used |
| | | to prevent access to calculated fields such as |
| | | checksum. |
| <Calculation> | <Calculation> | Indicates the field is calculated and provides |
| | <Type>Checksum</Type> | the parameters for the calculation. |
| | <Start>Version</Start> | |
| | <End>Destination Address</End> | |
| | </Calculation> | |
| <Start> | <Start>IP:Version</Start> | Indicates the calculation starting point. |
| <End> | <End>IP:Destination Address</End> | Indicates the calculation ending point. |

In the example shown in Table 1, a TCP/IP packet is being defined using an XML protocol file. There are three protocols required to build a TCP/IP packet: MAC, IP, and TCP. The TCP protocol is encapsulated in the IP protocol, and the IP protocol is encapsulated in the MAC protocol. The MAC protocol has three defined fields: destination address, source address, and type. The IP protocol has 10 defined fields: version, header length, type of service, total length, identification, fragment, protocol, checksum, source address, and destination address. Two of these fields, total length and checksum, cannot be edited and require a calculation. In the example of Table 1, the Source IP field is an IP address, has a field size of 16 bits, and has a default value of 10.0.0.1. The IP protocol also has a field that requires a checksum calculation. The TCP protocol has 15 defined fields: source port, destination port, sequence number, acknowledgement number, header length, acknowledge, push, reset connection, synchronize, finished, urgent, window, checksum (requires a checksum calculation and cannot be edited), urgent pointer, and payload.

The following is exemplary code for an XML protocol file that corresponds to the example described above:

```
<Protocol>
  <Count>3</Count>
  <Encapsulation>TCP:IP</Encapsulation>
  <Header_1>MAC</Header_1>
  <Header_2>IP</Header_2>
  <Header_3>TCP</Header_3>
</Protocol>
<TCP:IP>
  <MAC>
    <Destination Address>
      <Type>Text</Type>
      <Size>48</Size>
      <Default>00 01 02 03 04 05</Default>
    </Destination Address>
    <Source Address>
      <Type>Text</Type>
      <Size>48</Size>
      <Default>00 01 02 03 04 06</Default>
    </Source Address>
    <Type>
      <Type>Integer</Type>
      <Size>16</Size>
      <Default>2048</Default>
    </Type>
  </MAC>
  <IP>
    <Version>
      <Type>Integer</Type>
      <Size>8</Size>
      <Default>4</Default>
    </Version>
    <Header Length>
      <Type>Integer</Type>
      <Size>8</Size>
      <Default>20</Default>
    </Header Length>
    <Type of Service>
      <Type>Integer</Type>
      <Size>8</Size>
      <Default>0</Default>
    </Type of Service>
    <Total Length>
      <Type>Integer</Type>
      <Size>16</Size>
      <Default>0</Default>
      <Allow Edit>False</Allow Edit>
      <Calculation>
        <Type>Length</Type>
      </Calculation>
    </Total Length>
    <Identification>
      <Type>Integer</Type>
      <Size>16</Size>
      <Default>0</Default>
    </Identification>
    <Fragment>
      <Type>Integer</Type>
      <Size>16</Size>
      <Default>8192</Default>
    </Fragment>
    <Protocol>
      <Type>Integer</Type>
      <Size>8</Size>
      <Default>6</Default>
    </Protocol>
    <Checksum>
      <Type>Integer</Type>
      <Size>16</Size>
      <Default>0</Default>
      <Allow Edit>False</Allow Edit>
      <Calculation>
        <Type>Checksum</Type>
        <Start>Version</Start>
        <End>Destination Address</End>
      </Calculation>
    </Checksum>
    <Source Address>
      <Type>IP Address</Type>
      <Size>32</Size>
      <Default>0</Default>
    </Source Address>
    <Destination Address>
      <Type>IP Address</Type>
      <Size>32</Size>
      <Default>0</Default>
    </Destination Address>
  </IP>
  <TCP>
    <Source Port>
      <Type>Integer</Type>
      <Size>16</Size>
      <Default>0</Default>
    </Source Port>
    <Destination Port>
      <Type>Integer</Type>
      <Size>16</Size>
      <Default>0</Default>
    </Destination Port>
    <Sequence Number>
      <Type>Integer</Type>
      <Size>32</Size>
      <Default>0</Default>
    </Sequence Number>
    <Acknowledgement Number>
      <Type>Integer</Type>
      <Size>32</Size>
      <Default>0</Default>
    </Acknowledgement Number>
    <Header Length>
      <Type>Integer</Type>
      <Size>8</Size>
      <Default>20</Default>
    </Header Length>
    <Acknowledge>
      <Type>Boolean</Type>
      <Size>8</Size>
      <Default>False</Default>
    </Acknowledge>
    <Push>
      <Type>Boolean</Type>
      <Size>8</Size>
      <Default>False</Default>
    </Push>
    <Reset Connection>
      <Type>Boolean</Type>
      <Size>8</Size>
      <Default>False</Default>
    </Reset Connection>
    <Synchronize>
      <Type>Boolean</Type>
      <Size>8</Size>
      <Default>False</Default>
    </Synchronize>
    <Finished>
      <Type>Boolean</Type>
      <Size>8</Size>
      <Default>False</Default>
    </Finished>
    <Urgent>
      <Type>Boolean</Type>
      <Size>8</Size>
      <Default>False</Default>
    </Urgent>
    <Window>
      <Type>Integer</Type>
      <Size>16</Size>
      <Default>0</Default>
    </Window>
    <Checksum>
      <Type>Integer</Type>
      <Size>16</Size>
      <Default>0</Default>
      <Allow Edit>False</Allow Edit>
      <Calculation>True
        <Type>Checksum</Type>
        <Begin>IP::Source Address</Begin>
        <End>Payload</End>
      </Calculation>
    </Checksum>
    <Urgent Pointer>
      <Type>Integer</Type>
      <Size>16</Size>
      <Default>0</Default>
    </Urgent Pointer>
    <Payload>
      <Type>Text</Type>
      <Default>00 01 02 03</Default>
    </Payload>
  </TCP>
</TCP:IP>
```

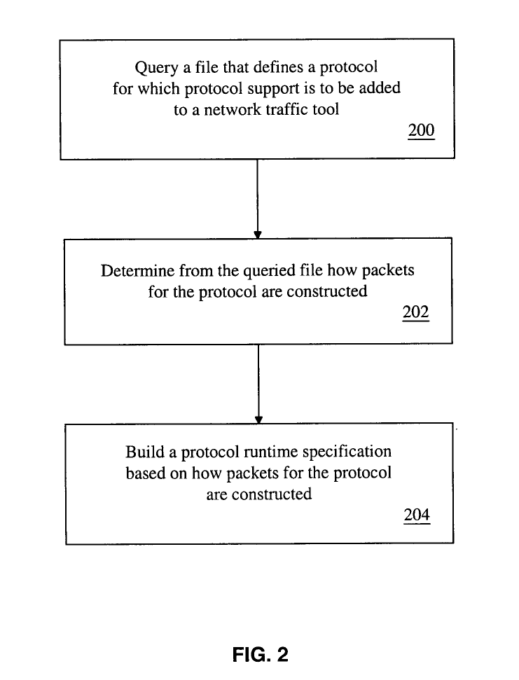

FIG. 2 illustrates a method according to one embodiment of the invention. At 200, a protocol file is queried that defines a protocol for which protocol support is to be added to a network traffic tool. In one embodiment, the file is an XML file. At 202, a determination is made from the queried file as to how packets for the protocol are constructed. In one embodiment, a determination is also made as to how user interface elements are displayed. At 204, a protocol runtime specification is built based on how packets for the protocol are constructed.

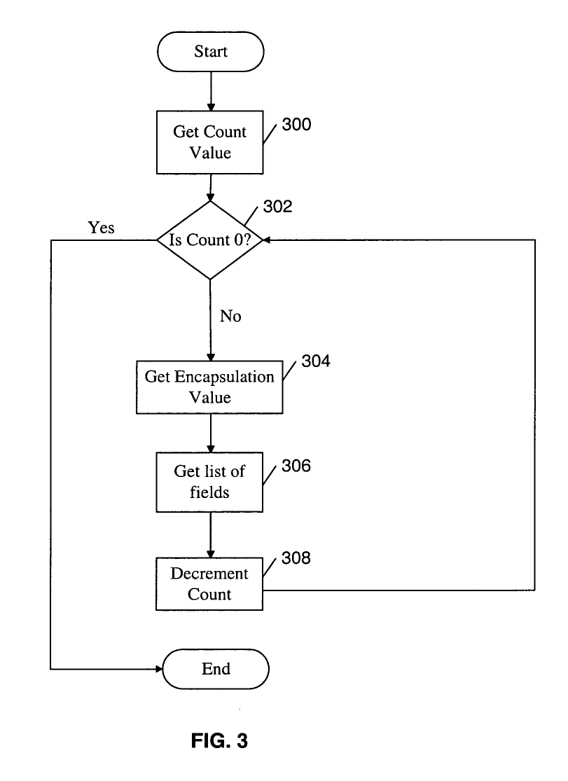

FIG. 3 illustrates a method of querying the protocol file according to one embodiment of the invention. At 300, a count value is determined. This count value indicates how many encapsulations are to be supported by the network traffic tool for the protocol being defined by the protocol file. At 302, a determination is made as to whether the count value is zero. If so, then the process ends. If not, then at 304, an encapsulation value is determined. This determination ascertains which protocols are encapsulated. The specifications of the encapsulated protocols are then determined by querying the protocol file. At 306, a list of fields is obtained from the protocol file. In one embodiment, a determination is first made as to whether there are any field parameters. If not, the process continues at 308. If so, the field parameters are obtained, such as the field type and size. In one embodiment, a determination is made as to whether a default tag exists. If so, the default tag is obtained. If not, then the default tag is set to a valid value based on the data type of the field. In one embodiment, a determination is made as to whether a calculation tag exists. If so, the calculation parameters are determined, such as the start value and end value, and the calculation may then be executed. The next item in the list of fields is then processed. When there are no items left in the field list to be processed, the process continues to 308. At 308, the count is decremented. Then, the process repeats from 302, where a determination is made as to whether the count is zero. When the count reaches zero, the process of querying the protocol file is complete. Other protocol files may then be queried for definitions of other protocols.

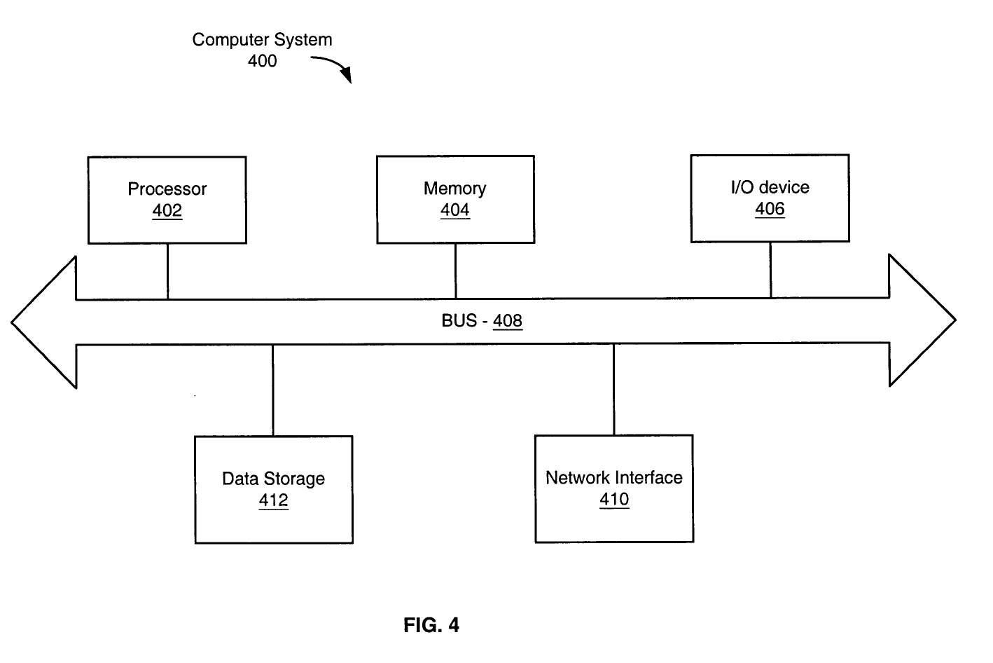

FIG. 4 is a block diagram illustrating a suitable computing environment in which certain aspects of the illustrated invention may be practiced. In one embodiment, the method described above may be implemented on a computer network traffic tool 400 having components 402-412, including a processor 402, memory 404, an Input/Output device 406, a data storage device 412, and a network interface 410, coupled to each other via a bus 408. The components perform their conventional functions known in the art and provide the means for implementing the network traffic tool 100. Collectively, these components represent a broad category of hardware systems, including but not limited to general purpose computer systems and specialized packet forwarding devices. It is to be appreciated that various components of computer system 400 may be rearranged, and that certain implementations of the present invention may not require nor include all of the above components. Furthermore, additional components may be included in system 400, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by network traffic tool 100, as part of or in addition to memory, including but not limited to cartridges, magnetic cassettes, flash memory cards, digital video disks, random access memories (RAMs), read-only memories (ROMs), and the like. In this regard, the network traffic tool 100 is equipped to communicate with such machine-readable media in a manner well-known in the art.

It will be further appreciated by those skilled in the art that the content for implementing an embodiment of the method of the invention may be provided to the network traffic tool 100 from any external device capable of storing the content and communicating the content to the network traffic tool 100. For example, in one embodiment of the invention, the network traffic tool 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
querying a file that defines a protocol for which protocol support is to be added to a network traffic tool;
determining from the queried file how packets for the protocols are constructed; and
building a protocol runtime specification based on how packets for the protocol are constructed.

2. The method of claim 1, wherein the file is written in an Extensible Markup Language (XML).

3. The method of claim 1, further comprising determining from the file how to display one or more user interface elements.

4. The method of claim 1, wherein determining from the queried file how packets for the protocol are constructed comprises determining whether there are one or more protocol encapsulations.

5. The method of claim 1, wherein determining from the queried file how packets for the protocol are constructed comprises determining a field type of one or more fields for the protocol.

6. The method of claim 1, wherein determining from the queried file how packets for the protocol are constructed comprises determining a field size of one or more fields for the protocol.

7. The method of claim 1, wherein determining from the queried file how packets for the protocol are constructed comprises determining a default value of one or more fields for the protocol.

8. The method of claim 1, wherein determining from the queried file how packets for the protocol are constructed comprises determining whether there is a calculation to be performed for one or more fields of the protocol.

9. An apparatus comprising:
a storage element to store a file that defines a protocol for which protocol support is to be added to a network traffic tool; and
a translation unit coupled to the storage element to query the file to determine how packets for the protocol are constructed and to build a protocol runtime specification for the protocol.

10. The apparatus of claim 9, further comprising a network interface coupled to the translation unit.

11. The apparatus of claim 9, wherein the stored file is written in an Extensible Markup Language (XML).

12. The apparatus of claim 9, wherein the translation unit further determines from the file how to display one or more user interface elements.

13. An article of manufacture comprising:
a machine accessible medium including content that when accessed by a machine causes the machine to:
query a file that defines a protocol for which protocol support is to be added to a network traffic tool;
determine from the queried file how packets for the protocol are constructed; and
build a protocol runtime specification based on how packets for the protocol are constructed.

14. The article of manufacture of claim 13, wherein the file is written in an Extensible Markup Language (XML).

15. The article of manufacture of claim 13, wherein the machine-accessible medium further includes content that causes the machine to determine from the file how to display one or more user interface elements.

16. The article of manufacture of claim 13, wherein the machine accessible medium including content that when accessed by the machine causes the machine to determine from the queried file how packets for the protocol are constructed comprises the machine accessible medium including content that when accessed by the machine causes the machine to determine whether there are one or more protocol encapsulations.

17. The article of manufacture of claim 13, wherein the machine accessible medium including content that when accessed by the machine causes the machine to determine from the queried file how packets for the protocol are constructed comprises the machine accessible medium including content that when accessed by the machine causes the machine to determine a field type of one or more fields for the protocol.

18. The article of manufacture of claim 13, wherein the machine accessible medium including content that when accessed by the machine causes the machine to determine from the queried file how packets for the protocol are constructed comprises the machine accessible medium including content that when accessed by the machine causes the machine to determine a field size of one or more fields for the protocol.

19. The article of manufacture of claim 13, wherein the machine accessible medium including content that when accessed by the machine causes the machine to determine from the queried file how packets for the protocol are constructed comprises the machine accessible medium including content that when accessed by the machine causes the machine to determine a default value of one or more fields for the protocol.

20. The article of manufacture of claim 13, wherein the machine accessible medium including content that when accessed by the machine causes the machine to determine from the queried file how packets for the protocol are constructed comprises the machine accessible medium including content that when accessed by the machine causes the machine to determine whether there is a calculation to be performed for one or more fields of the protocol.

21. A system comprising:
a storage element to store a file that defines protocol for which protocol support is to be added to a network traffic tool;
a translation unit coupled to the storage element to query the file to determine how packets for the protocol are constructed and to build a protocol runtime specification for the protocol;
a network interface coupled to the translation unit; and
a network driver coupled to the network interface.

22. The system of claim 21, wherein the stored file is written in an Extensible Markup Language (XML).

23. The system of claim 21, wherein the translation unit further determines from the file how to display one or more user interface elements.
